(19) United States
(12) Patent Application Publication
(10) Pub. No.: US 2024/0169495 A1
(43) Pub. Date: May 23, 2024

(54) DETERMINING POINT SPREAD FUNCTION FROM CONSECUTIVE IMAGES

(71) Applicant: Varjo Technologies Oy, Helsinki (FI)

(72) Inventors: Mikko Ollila, Tampere (FI); Mikko Strandborg, Hangonkylä (FI)

(73) Assignee: Varjo Technologies Oy, Helsinki (FI)

(21) Appl. No.: 17/991,576

(22) Filed: Nov. 21, 2022

(51) Int. Cl. G06T 5/00; G06T 7/80

(52) U.S. Cl. CPC G06T 5/003; G06T 7/80; G06T 2207/10016; G06T 2207/10148; G06T 2207/30201

(57) ABSTRACT

A method includes obtaining sequence(s) of images captured consecutively using camera(s), wherein optical focus of camera(s) is switched between different focusing distances; for pair of first and second images captured consecutively by adjusting optical focus of camera(s) at first and second focusing distances, respectively, assuming at least part of first image is in focus, whilst corresponding part of second image is out of focus, and determining point spread function (PSF) for camera(s), based on correlation between pixels of at least part of first image and respective pixels of corresponding part of second image, and first focusing distance range covered by depth of field of camera(s) around first focusing distance; and for third image captured by adjusting optical focus at third focusing distance, applying extended depth-of-field correction to segment(s) of third image that is/are out of focus.

### TECHNICAL FIELD

The present disclosure relates to computer-implemented methods for determining point spread functions (PSFs) from consecutive images. The present disclosure relates to systems for determining PSFs from consecutive images. The present disclosure relates to computer-program products for determining PSFs from consecutive images.

### BACKGROUND

Nowadays, with increase in number of images being captured every day, there is an increased demand for image processing, specifically for image enhancement. Such a demand may, for example, be quite high and critical in case of evolving technologies such as immersive extended-reality (XR) technologies, which are being employed in various fields such as entertainment, real estate, training, medical imaging operations, simulators, navigation, and the like. Such immersive XR technologies create XR environments for presentation to users of XR devices (such as XR headsets, pairs of XR glasses, or similar). Generally, the image processing is used to perform certain operations on the images captured by a camera to ensure that the images convey useful and rich visual information throughout their fields of view.

Despite progress in cameras used for image capturing, existing techniques and equipment for image generation have several limitations associated therewith. Firstly, cameras used for image capturing typically suffer from depth-of-field issues. Such depth-of-field issues can be resolved to some extent by adjusting a size of an aperture of a given camera. However, when the size of the aperture of the given camera is significantly smaller, images of a real-world environment in a low-light setting are not captured properly by the given camera. Moreover, larger the size of the aperture, narrower is the depth-of-field. Furthermore, even when an auto-focus camera is employed for capturing the images, it is still not possible to capture sharp (i.e., in-focus) images in an entire field of view, because the auto-focus camera can be adjusted according to only one focusing distance range at a time. In other words, images of the real-world environment are sharply captured only within a given focusing distance range of the given camera, and are captured blurred outside the given focusing distance range. Therefore, the generated images are of low quality and unrealistic, and are often generated with considerable latency/delay. Secondly, existing techniques for generating images using a stereo pair of cameras are suitable only for a single user, and thus multiple users gazing at different optical depths cannot be served by such existing techniques. Thirdly, some existing techniques and equipment exclusively rely on depth cameras for capturing depth information of the real-world environment in order to correct out-of-focus images. However, such depth information is generally unreliable and inaccurate because of similar depth-of-field issues in the depth cameras. Thus, image correction lacks a required resolution.

Therefore, in light of the foregoing discussion, there exists a need to overcome the aforementioned drawbacks associated with existing equipment and techniques for image generation.

### SUMMARY

The present disclosure seeks to provide a computer-implemented method for determining point spread functions (PSF) from consecutive images. The present disclosure also seeks to provide a system for determining PSF from consecutive images. The present disclosure further seeks to provide a computer program product for determining PSF from consecutive images. An aim of the present disclosure is to provide a solution that overcomes at least partially the problems encountered in prior art.

In a first aspect, an embodiment of the present disclosure provides a computer-implemented method comprising:
obtaining at least one sequence of images of a real-world environment captured consecutively using at least one camera, wherein an optical focus of the at least one camera is switched between different focusing distances whilst capturing consecutive images of said sequence;
for a given pair of a first image and a second image that are captured consecutively in said sequence by adjusting the optical focus of the at least one camera at a first focusing distance and a second focusing distance, respectively,
   assuming that at least a part of the first image is in focus, whilst a corresponding part of the second image is out of focus; and
   determining a point spread function for the at least one camera, based on a correlation between pixels of at least the part of the first image and respective pixels of the corresponding part of the second image, and a first focusing distance range covered by a depth of field of the at least one camera around the first focusing distance; and
for a third image of the real-world environment captured by adjusting the optical focus of the at least one camera at a third focusing distance, applying an extended depth-of-field correction to at least one segment of the third image that is out of focus, by using the point spread function determined for the at least one camera.

In a second aspect, an embodiment of the present disclosure provides a system comprising:
at least one server configured to:
   obtain at least one sequence of images of a real-world environment captured consecutively using at least one camera, wherein an optical focus of the at least one camera is switched between different focusing distances whilst capturing consecutive images of said sequence;
   for a given pair of a first image and a second image that are captured consecutively in said sequence by adjusting the optical focus of the at least one camera at a first focusing distance and a second focusing distance, respectively,
      assume that at least a part of the first image is in focus, whilst a corresponding part of the second image is out of focus; and
      determine a point spread function for the at least one camera, based on a correlation between pixels of at least the part of the first image and respective pixels of the corresponding part of the second image, and a first focusing distance range covered by a depth of field of the at least one camera around the first focusing distance; and
for a third image of the real-world environment captured by adjusting the optical focus of the at least one camera at a third focusing distance, apply an extended depth-of-field correction to at least one segment of the third image that is out of focus, by using the point spread function determined for the at least one camera.

In a third aspect, an embodiment of the present disclosure provides a computer program product comprising a non-transitory machine-readable data storage medium having stored thereon program instructions that, when executed by a processor, cause the processor to execute steps of a computer-implemented method of the first aspect.

Embodiments of the present disclosure substantially eliminate or at least partially address the aforementioned problems in the prior art, and facilitate a simple, fast, accurate, and improved image deblurring by way of employing the point spread function that is determined using consecutive images, thereby generating images having high realism and high visual fidelity, in real time or near-real time.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 illustrates steps of a method for determining point spread function from consecutive images, in accordance with an embodiment of the present disclosure;

FIG. 2 illustrates a block diagram of architecture of a system for determining point spread function from consecutive images, in accordance with an embodiment of the present disclosure; and

FIG. 3 illustrates how a point spread function is determined using exemplary cycles of consecutive images, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a computer-implemented method comprising:
obtaining at least one sequence of images of a real-world environment captured consecutively using at least one camera, wherein an optical focus of the at least one camera is switched between different focusing distances whilst capturing consecutive images of said sequence;
for a given pair of a first image and a second image that are captured consecutively in said sequence by adjusting the optical focus of the at least one camera at a first focusing distance and a second focusing distance, respectively,
   assuming that at least a part of the first image is in focus, whilst a corresponding part of the second image is out of focus; and
   determining a point spread function for the at least one camera, based on a correlation between pixels of at least the part of the first image and respective pixels of the corresponding part of the second image, and a first focusing distance range covered by a depth of field of the at least one camera around the first focusing distance; and
for a third image of the real-world environment captured by adjusting the optical focus of the at least one camera at a third focusing distance, applying an extended depth-of-field correction to at least one segment of the third image that is out of focus, by using the point spread function determined for the at least one camera.

In a second aspect, an embodiment of the present disclosure provides a system comprising:

at least one server configured to:
obtain at least one sequence of images of a real-world environment captured consecutively using at least one camera, wherein an optical focus of the at least one camera is switched between different focusing distances whilst capturing consecutive images of said sequence;
for a given pair of a first image and a second image that are captured consecutively in said sequence by adjusting the optical focus of the at least one camera at a first focusing distance and a second focusing distance, respectively,
   assume that at least a part of the first image is in focus, whilst a corresponding part of the second image is out of focus; and
   determine a point spread function for the at least one camera, based on a correlation between pixels of at least the part of the first image and respective pixels of the corresponding part of the second image, and a first focusing distance range covered by a depth of field of the at least one camera around the first focusing distance; and
for a third image of the real-world environment captured by adjusting the optical focus of the at least one camera at a third focusing distance, apply an extended depth-of-field correction to at least one segment of the third image that is out of focus, by using the point spread function determined for the at least one camera.

In a third aspect, an embodiment of the present disclosure provides a computer program product comprising a non-transitory machine-readable data storage medium having stored thereon program instructions that, when executed by a processor, cause the processor to execute steps of the computer-implemented method of the first aspect.

The present disclosure provides the aforementioned method, the aforementioned system, and the aforementioned computer program product for facilitating a simple, fast, accurate, and improved image deblurring by way of employing the point spread function that is determined using consecutive images, thereby generating images having high realism and high visual fidelity. Herein, the point spread function is used for applying the extended depth-of-field (EDOF) correction to the at least one image segment of the third image that is out of focus. In this way, high-quality and accurate images are generated in real time or near-real time even when the at least one camera has depth-of-field issues. EDOF-corrected images are accurate and realistic, for example, in terms of representing objects or their parts. This potentially leads to a realistic, immersive viewing experience for one or more users, when the images are displayed to the one or more users. The method and the system do not necessarily require depth cameras for sensing optical depths of objects, in order to determine the PSF. Notably, using such an approximate PSF (namely, without a need to take actual optical depths of pixels into consideration) makes the process of EDOF correction faster, efficient, and lightweight. It will be appreciated that the aforementioned method can be utilised to determine the PSF from two consecutive images, wherein at least a part of one of the two consecutive images is assumed to be in focus, while a corresponding part of another of the two consecutive images is assumed to be out of focus; the PSF could then be utilized to deblur the another of the two consecutive images and/or another subsequent image in the at least one sequence of images. This allows a sufficiently good EDOF correction to be performed in real-time in a fast and efficient manner. The method and the system are simple, robust, fast, reliable, support real-time high-quality image deblurring and can be implemented with ease.

Notably, the at least one server controls an overall operation of the system. In some implementations, the at least one server is implemented as a remote server. In such implementations, the remote server is separately located from the at least one camera. Moreover, the remote server receives the at least one sequence of images from the at least one camera (or a device comprising the at least one camera), or from a data repository in which the at least one sequence of images is pre-stored. As an example, the remote server could be a cloud server that provides a cloud computing service. Examples of the device include, but are not limited to, a head-mounted display (HMD) device and a teleport device. In other implementations, the at least one server is implemented as a processor of a computing device. Examples of the computing device include, but are not limited to, a laptop, a desktop computer, a tablet, a phablet, a personal digital assistant, a workstation, a console.

The term “head-mounted display” device refers to a specialized equipment that is configured to present an extended-reality (XR) environment to a user when said HMD device, in operation, is worn by the user on his/her head. The HMD device is implemented, for example, as an XR headset, a pair of XR glasses, and the like, that is operable to display a scene of the XR environment to the user. The term “extended-reality” encompasses virtual reality (VR), augmented reality (AR), mixed reality (MR), and the like. The term “teleport device” refers to a specialized equipment that is capable of facilitating virtual teleportation.

It will be appreciated that the term “at least one server” refers to a “a single server” in some implementations, and to a “a plurality of servers” in other implementations. When the system comprises the single server, all operations of the system are performed by the single server. When the system comprises the plurality of servers, different operations of the system can be performed by different (and specially configured) servers from amongst the plurality of servers. As an example, the first server from amongst the plurality of servers may be configured to determine the point spread function (PSF) for the at least one camera, and a second server from amongst the plurality of servers may be configured to apply the extended depth-of-field (EDOF) correction to the at least one image segment of the third image that is out of focus.

It will also be appreciated that the computer-implemented method is preferably (fully) implemented by the at least one server. However, the computer-implemented method can be implemented by the at least one server and the device in a shared manner i.e., said method can be partly implemented by the device. Alternatively, the computer-implemented method can be fully implemented by the device.

A given image is a visual representation of the real-world environment. The term “visual representation” encompasses colour information represented in the given image, and additionally optionally other attributes associated with the given image (for example, such as depth information, luminance information, transparency information, and the like).

Optionally, the at least one server is configured to obtain the at least one sequence of images from any one of:
the at least one camera,
the device comprising the at least one camera,
the data repository in which the at least one sequence of images is pre-stored.

It will be appreciated that the data repository could, for example, be implemented as a memory of the at least one server, a memory of the device, a memory of the computing device, a removable memory, a cloud-based database, or similar. Optionally, the system further comprises the data repository.

Throughout the present disclosure, the term “camera” refers to an equipment that is operable to detect and process light signals received from the real-world environment, so as to capture images of the real-world environment. Optionally, the at least one camera is implemented as a visible-light camera. Examples of the visible-light camera include, but are not limited to, a Red-Green-Blue (RGB) camera, a Red-Green-Blue-Alpha (RGB-A) camera, a Red-Green-Blue-Depth (RGB-D) camera, an event camera, a Red-Green-Blue-White (RGBW) camera, a Red-Yellow-Yellow-Blue (RYYB) camera, a Red-Green-Green-Blue (RGGB) camera, a Red-Clear-Clear-Blue (RCCB) camera, a Red-Green-Blue-Infrared (RGB-IR) camera, and a monochrome camera. Additionally, optionally, the at least one camera is implemented as a depth camera. Examples of the depth camera include, but are limited to, a Time-of-Flight (ToF) camera, a light detection and ranging (LiDAR) camera, a Red-Green-Blue-Depth (RGB-D) camera, a laser rangefinder, a stereo camera, a plenoptic camera, an infrared (IR) camera, a ranging camera, a Sound Navigation and Ranging (SONAR) camera. The at least one camera is optionally implemented as a combination of the visible-light camera and the depth camera. The at least one camera may have a sensor chip having some phase detection autofocus (PDAF) pixels. Optionally, the at least one camera (or the device comprising the at least one camera) is communicably coupled to the at least one server.

Notably, the at least one camera has an adjustable optical focus. This means that the at least one camera is focusable i.e., a focal plane of at least one optical element (for example, such as a camera lens) of the at least one camera is adjustable between the different focusing distances (namely, different optical depths and their corresponding depths of field). Such an adjustment facilitates in capturing sharp images of objects present in the real-world environment in which the at least one camera is present.

In an embodiment, the optical focus of the at least one camera is switched between N different focusing distances whilst capturing consecutive images of said sequence, the N different focusing distances comprising fixed focusing distances. In this regard, the at least one server sends information indicative of the fixed focusing distances to the at least one camera only once, wherein the at least one camera utilises this information for capturing the consecutive images of said sequence. In such a case, the at least one server would not need to wait for receiving (from devices of N users) any information indicative of optical depths at which the N users are gazing, and then send said information to the at least one camera for capturing the aforesaid images. Advantageously, image capturing operations of the at least one camera are performed in real-time or near-real time (without any latency/delay).

It will be appreciated that the fixed focusing distances are selected by the at least one server in a manner that the fixed focusing distances would cover a wide range of focusing distances of the at least one camera. Beneficially, this facilitates in capturing high-quality images at the different focusing distances.

In an example, for each cycle of four consecutive images, four fixed focusing distances can be employed for the at least one camera. The four fixed focusing distances could, for example, be as follows:
65 cm (for covering a focusing distance range of 54 cm to 82 cm),
85 cm (for covering a focusing distance range of 67 cm to 117 cm),
1.5 m (for covering a focusing distance range of 1.0 m to 2.9 m), and
2.5 m (for covering a focusing distance range of 1.4 m to 13.1 m).

The aforesaid four fixed focusing distances have been calculated, for example, for a case when a pixel size is 1.4 micrometres, a focal length of the at least one camera is 4.9 millimetres, and an aperture of the at least one camera is f/2.8.

It will also be appreciated that the fixed focusing distances could be changed (namely, modified), for example, when the at least one server determines that the N users are gazing only at nearby objects and/or at objects lying at intermediate distances for a time period greater than a predefined threshold. In other words, when the at least one server determines that the N users are not at all gazing at faraway objects, the at least one server could modify at least one of the fixed focusing distances accordingly. Furthermore, for each cycle of consecutive images, a sequence in which the N fixed focusing distances are employed for the at least one camera could be selected randomly. Same sequence or different sequences may be employed for subsequent cycles of consecutive images. In an example, for each cycle of four consecutive images, a sequence of employing four fixed focusing distances for the at least one camera may be: 1.5 m, 2.5 m, 65 cm, 85 cm.

In another embodiment, the optical focus of the at least one camera is switched between N different focusing distances whilst capturing consecutive images of said sequence, wherein the N different focusing distances correspond to optical depths at which N users are gazing. In this regard, each of the consecutive images of said sequence corresponds to an optical depth at which a different one of the N users is gazing. Therefore, in such a case, the at least one server receives a given image (from amongst the consecutive images) captured by adjusting the optical focus of the at least one camera according to a given focusing distance that corresponds to a given optical depth at which a given user (from amongst the N users) is gazing. In an example, the first image and the second image may correspond to respective optical depths at which a first user and a second user from amongst the N users are gazing, respectively.

Optionally, a processor of a given device (associated with the given user) is configured to determine the given optical depth at which the given user is gazing, based on a convergence of gaze directions of the given user's eyes. In this regard, the given optical depth can be determined, based on an interpupillary distance (IPD) of the given user, by using a triangulation technique. Additionally or alternatively, optionally, the processor of the given client device is configured to determine the given optical depth at which the given user is gazing, based on a depth map of a real-world scene of the real-world environment and a given gaze direction of a given eye of the given user.

Notably, when both the first image and the second image are captured consecutively in said sequence, it is highly likely that a field of view of the first image and a field of view of the second image almost fully overlap with each other, i.e., a change in the aforesaid fields of view (namely, a mismatch between the aforesaid fields of view) is minimal. In this regard, objects represented in the first image and in the second image are mostly same objects. However, there may be an instance that a pose from which the first image is captured would be (slightly) different from a pose from which the second image is captured. In this regard, the at least one server is optionally configured to reproject one of the first image and the second image to match a perspective from which another of the first image and the second image is captured, prior to determining the point spread function. It will be appreciated that the aforesaid reprojection could be based on a head pose of a given user of the given device comprising the at least one camera, and optionally, a gaze direction of the given user. Image reprojection techniques are well-known in the art.

By assuming that at least the part of the first image is in focus, whilst the corresponding part of the second image is out of focus, it is meant that optical depths of pixels in said part of the first image and optical depths of respective pixels in the corresponding part of the second image are assumed to lie within the first focusing distance range covered by the depth of field of the at least one camera around the first focusing distance. Beneficially, this facilitates in determining an approximately accurate PSF (that is independent of any optical depth value). It will be appreciated that the phrase “at least the part of the first image is in focus” means that either some part(s) of the first image is/are in focus (while remaining part(s) of the first image is/are out of focus), or an entirety of the first image is in focus. Therefore, when the some part(s) of the first image is/are assumed to be in focus, corresponding part(s) of the second image is/are assumed to be out of focus. When the entirety of the first image is assumed to be in focus, the entirety of the second image is assumed to be out of focus. It is to be understood that when at least the part of the first image is in focus, whilst the corresponding part of the second image is out of focus, a same object appears to be sharp and high-resolution in at least the part of the first image, and the same object appears to be blurred in the corresponding part of the second image. Pursuant to embodiments, such a blur is assumed to be a defocus blur.

Throughout the present disclosure, the term “point spread function” refers to responses of at least one optical element of the at least one camera to any one of: a point source, a point object. Ideally, the PSF is a two-dimensional (2D) diffraction pattern of light that is formed when an infinitely small point-like light source is imaged through the at least one optical element (for example, a lens system) of the at least one camera. A shape of the PSF is affected by optical properties of the at least one optical element, a distance between the infinitely small point-like light source and the at least one optical element, and a location of said light source within a field-of-view of the at least one camera. However, in practice, PSFs often appear like a Gaussian function, due to at least one of: diffraction of light, aberration of the at least one optical element, image sensing. The at least one optical element could be a lens of the at least one camera. The PSF is a measure for the quality of the at least one camera, as it reveals how at least one point is blurred in a given image captured by the at least one camera. The PSF allows for correction of out-of-focus blur in the given image, i.e., for deblurring the given image. If there is no out-of-focus blur, the given image does not require any deblurring and thus the PSF is centred about zero. The out-of-focus blur causes the PSF to move away from zero by an amount that is directly proportional to a shift in a pixel of the given image. Knowing the PSF is important for restoring sharpness of an (original) object with deconvolution in the given image. The PSF may be independent of a position in a plane of the object. The PSF of the at least one camera varies depending on a wavelength of light received by the at least one camera from the real-world environment. For example, a shorter wavelength of the light (for example, such as a blue light having a wavelength of 450 nanometres) result in a PSF that would be smaller than a PSF corresponding to a longer wavelength of the light (for example, such as a red light having a wavelength of 650 nanometres). The PSF may further depend on a numerical aperture (NA) of the lens (such as an objective lens) of the at least one camera. In an example, an objective lens having a higher NA may result in a smaller PSF as compared to an objective lens having a smaller NA. Moreover, the PSF may vary spatially across the lens. In other words, the PSF may vary across a field-of-view of the lens.

This may be due to manufacturing tolerances of the lens which deteriorate the PSF towards edges of the lens. For example, a PSF for a point along an optical axis of the lens can be (slightly) different from a PSF for a point that is towards a periphery of the field-of-view of the lens. Thus, it is difficult to design a lens which projects a point to an image plane when moving from a centre of the lens towards an edge of the lens.

The correlation between the pixels of at least the part of the first image and the respective pixels of the corresponding part of the second image refers to a mathematical relation between pixel values of the pixels of at least the part of the first image and pixel values of the respective pixels of the corresponding part of the second image. The aforesaid correlation could be determined by the at least one server using at least one of: a mathematical formula, a mathematical function, a mapping between a given pixel of the first image and a respective pixel of the second image. Techniques for determining a correlation between pixels of different images are well-known in the art. One example of such a technique has been described hereinbelow. A person skilled in the art will recognize many variations, alternatives, and modifications of techniques for determining the PSF.

It will be appreciated that the determination of the PSF can be represented mathematically as follows:

In the Fourier domain:

blurred_image_FT=ideal_image_FT*PSF_FT(Multiplication)

wherein, * (single asterisk) represents multiplication.

In other words, a Fourier transform of the blurred image is equal to a multiplication of a Fourier transform of the ideal image and a Fourier transform of the PSF.

Therefore, PSF_FT=blurred_image_FT/ideal_image_FT

PSF=inverseFT (blurred_image_FT/ideal_image_FT)

Thus, the PSF for the at least one camera can be determined by applying an inverse Fourier transform to a division of the Fourier transform of the blurred image and the Fourier transform of the ideal image. Hereinabove, the term “ideal image” refers to at least a part of the first image that is assumed to be in focus, while the term “blurred image” refers to the corresponding part of the second image that is assumed to be out of focus.

It will be appreciated that the PSF determined in this manner is acceptably accurate and reliable, and is easily determined without requiring actual optical depth values. Subsequently, this allows the EDOF correction to be suitably applied in real time or near-real time, and it would be light in terms of employing processing resources of the at least one server, as the consecutive images are captured with a sufficiently good image quality. Optionally, the at least one server is configured to store the determined PSF at the data repository.

In an embodiment, in the method, the step of assuming comprises assuming that an entirety of the first image is in focus, whilst an entirety of the second image is out of focus, and wherein the point spread function is determined based on a correlation between pixels of the first image and respective pixels of the second image, and the first focusing distance range. In this regard, the correlation between the pixels of the first image and the respective pixels of the second image refers to a mathematical relation between pixel values of the pixels of the first image and pixel values of the respective pixels of the second image. It will be appreciated that said correlation and the PSF can be determined in a manner as mentioned earlier.

The at least one server corrects the third image using the PSF determined for the at least one camera. The third image is a visual representation of the real-world environment that is captured from a perspective of a given pose of the at least one camera. Such a given pose could be same as a pose from which an out-of-focus image (for example, such as the second image) from amongst the consecutive images is captured. Alternatively, the given pose could be different from the aforesaid pose. Optionally, the third focusing distance is one of: the first focusing distance, the second focusing distance, a focusing distance that is different from the first focusing distance and the second focusing distance.

Throughout the present disclosure, the term “extended depth-of-field correction” refers to a corrective image processing operation that emulates a visual effect of extension of the depth-of-field over which objects or their parts in the real-world environment appear to be in-focus (i.e., well focused) in a given image. Herein, the term “depth-of-field” refers to a distance between a nearest point and a farthest point in the real-world environment that are acceptably sharply focused in the given image captured by the at least one camera. The term “given image” encompasses the third image. A nearest point lies in front of a focus point (for example, such as an object) on which a lens of the at least one camera is actually focused, while the farthest point lies behind the focus point. The nearest point and the farthest point may be at an equal distance or at an unequal distance from the focus point. The depth-of-field may be determined by a focal length of the lens of the at least one camera, a distance to the object, an aperture, or similar. The extension of the depth-of-field does not sacrifice resolution or brightness, thereby clearly capturing the objects in the real-world environment without a need to adjust the focus of the at least one camera and an angle between the objects and the at least one camera. The EDOF correction enables deblurring of the objects that lie outside of a focal region of the lens of the at least one camera (i.e., outside the depth-of-field of the lens of the at least one camera) to produce an extended-in-focus view of the real-world environment. The EDOF correction may be applied to generate in-focus images of at least one of: multiple objects present in at least a foreground and/or a background of a given object in the real-world environment, oblique objects, objects at different heights, objects at different depths.

When the at least one image segment of the third image is out of focus, this means optical depths corresponding to the at least one image segment of the third image lie outside a third focusing distance range of the at least one camera corresponding to the third focusing distance. Therefore, when the EDOF correction is applied to the at least one image segment of the third image, pixel values of the at least one image segment of the third image are corrected accordingly, by using the PSF. Beneficially, upon applying the EDOF correction, the at least one image segment of the third image appears realistic and highly accurate as objects represented in the at least one image segment appear acceptably sharp (i.e., well focused and clearly visible). Thus, an immersive and realistic viewing experience could, for example, be provided to a user viewing the third image. Optionally, the EDOF correction is applied by employing a Wiener filter based on the (determined) PSF for the at least one camera. Alternatively, the EDOF correction is performed by employing deconvolution utilizing a predetermined blur kernel.

Throughout the present disclosure, the term “image segment” of a given image refers to a portion (namely, a segment) of a given image that represents a given object or its part present in the real-world environment. The given image is at least one of: the first image, the second image, the third image.

In an example, four consecutive images I1, I2, I3, and I4 may be captured by adjusting the optical focus of the at least one camera according to four fixed focusing distances D1, D2, D3, and D4, which correspond to four focusing distance ranges R1, R2, R3, and R4 of the at least one camera, respectively. Herein, by correlating pixels of the image I1 and respective pixels of the image I2 and assuming the image I1 to be in focus and the image I2 to be out-of-focus, the PSF for the focusing distance range R1 (including the focusing distance D1) can be determined. By correlating pixels of the image I2 and respective pixels of the image I3 and assuming the image I2 to be in focus and the image I3 to be out-of-focus, the PSF for the focusing distance range R2 (including the focusing distance D2) can be determined. Likewise, the PSF for the focusing distance ranges R3 and R4 (including the focusing distances D3 and D4, respectively) can also be determined. Consider an example of the image I3, where objects present within the focusing distance range R3 (namely, at the optical depth D3 and its associated depth of field) would be captured sharply (namely, well-focused). Thus, EDOF correction(s) can be applied to the image I3, using at least one of: the PSF for the focusing distance range R1 (corresponding to the focusing distance D1), the PSF for the focusing distance range R2 (corresponding to the focusing distance D2), the PSF for the focusing distance range R4 (corresponding to the focusing distance D4). Such an example has been also illustrated in conjunction with FIG. 3, for sake of better understanding.

It will be appreciated that one or more EDOF corrections could be applied to different image segments of the third image that are out of focus, while image segment(s) of the third image that are already in focus do not require any EDOF correction, because (unnecessarily) applying such an EDOF correction to the (in-focus) image segments of the third image would blur those image segments. The different image segments of the third image that are out of focus can be identified, for example, by using contrast analysis, edge detection, Fourier analysis, or similar. The aforesaid analyses and various edge detection techniques are well-known in the art. Additionally or alternatively, the different image segments of the third image that are out of focus can be identified using a depth map corresponding to the third image. This is because pixels of the third image whose optical depth values lie within the third focusing distance range (covered by a depth of field at the third focusing distance) would be in-focus pixels of the third image, while remaining pixels of the third image whose optical depth values lie within different focusing distance range(s) would be out-of-focus pixels of the third image. It is to be understood that optical depth values of all pixels of the third image can be easily known from the depth map corresponding to the third image.

It will also be appreciated that such a manner of correcting the third image is similar to a well-known focus stacking technique, wherein different in-focus regions of different images in the at least one sequence of consecutive images are utilized to generate an image that is entirely in focus. When using this technique, in-focus regions of each image amongst the different images may be automatically detected (for example, using edge detection or Fourier analysis) or manually selected.

Optionally, the third image is any one of: a previous image in said sequence, a subsequent image in said sequence, the second image. In this regard, when the third image is the previous image in said sequence, the PSF can be determined using a pair of images (i.e., a pair of an in-focus image and an out-of-focus image) that is subsequently captured to the third image in said sequence. Then, the EDOF correction can be applied to at least one segment of the third image (namely, the previous image) that is out of focus, by using the PSF. Likewise, when the third image is the subsequent image in said sequence, the PSF can be determined using the pair of images that is previously captured to the third image in said sequence. Then, the EDOF correction can be applied to at least one segment of the third image (namely, the subsequent image) that is out of focus, by using the PSF. It will be appreciated that the two aforesaid cases are possible when the consecutive images are made available (to the at least one server) either for previous time instants or for future time instants. Such consecutive images could, for example, be stored in a framebuffer memory associated with the at least one server. Therefore, the EDOF-corrected third image thus generated would have acceptable image quality, for example, for displaying purposes. Furthermore, when the third image is the second image (that is assumed to be out of focus), the PSF is determined using the pair of the first image and the second image as described earlier, and the EDOF correction can then also be applied to at least one segment of the second image that is out of focus.

In another embodiment, the computer-implemented method further comprises:
obtaining a plurality of depth maps captured corresponding to the images in said sequence; and
identifying at least one image segment of the first image and a corresponding image segment of the second image in which the at least one image segment of the first image is in focus whilst the corresponding image segment of the second image is out of focus,
   wherein the step of determining the point spread function is performed, based on a correlation between pixels of the at least one image segment of the first image and respective pixels of the corresponding image segment of the second image, and respective optical depths in at least one segment of a first depth map corresponding to the at least one image segment of the first image, wherein said part of the first image comprises the at least one image segment of the first image.

It will be appreciated that the at least one server is optionally configured to obtain a given depth map from any one of:
the given depth camera,
a device comprising the given depth camera,
the data repository in which the given depth map is pre-stored along with the given image.

Herein, the term “depth map” refers to a data structure comprising information pertaining to optical depths of objects or their parts present in the real-world environment. The given depth map provides information pertaining to distances (namely, optical depths) of surfaces of the objects or their parts, from a given viewpoint and a given viewing direction of the given depth camera. The given depth map is captured corresponding to the given image i.e., the given depth map is captured by the given depth camera from a same perspective from which the given image is captured by the given camera. In some implementations, the given depth camera could be integrated into the at least one camera. In some implementations, the given depth camera could be separate from the at least one camera. The term “object” refers to a physical object or a part of the physical object present in the real-world environment. The object could be a living object (for example, such as a human, a pet, a plant, and the like) or a non-living object (for example, such as a wall, a window, a toy, a poster, a lamp, and the like).

It will be appreciated that the given depth map could be generated using at least one of: depth from stereo, depth from focus, depth from reflectance, depth from shading, when a given camera has at least one of: a coded aperture, a sensor chip having phase detection autofocus (PDAF) pixels, a sensor chip in which some of its pixels are IR pixels. Such IR pixels can detect, for example, a structured light at an active-IR illumination. Moreover, the given depth map could also be generated even without using the given depth camera. In this regard, the given depth map could be generated by using at least one of: a neural network model, a monocular depth estimation technique, a Structure from Motion (SfM) technique.

Optionally, when identifying the at least one image segment of the first image and the corresponding image segment of the second image, the at least one server is configured to: extract features from the first image and the second image; and match a given feature in the first image with a corresponding feature in the second image. Examples of the features include, but are not limited to, edges, corners, blobs, ridges, high-frequency features (such as high frequency colour changes). Optionally, the at least one server is configured to employ at least one data processing algorithm for extracting features from the given image. Examples of the at least one data processing algorithm include, but are not limited to, an edge-detection algorithm (for example, such as Canny edge detector, Deriche edge detector and the like), a corner-detection algorithm (for example, such as Harris & Stephens corner detector, Shi-Tomasi corner detector, Features from Accelerated Segment Test (FAST) corner detector and the like), a blob-detection algorithm (for example, such as Laplacian of Gaussian (LoG)-based blob detector, Difference of Gaussians (DoG)-based blob detector, Maximally Stable Extremal Regions (MSER) blob detector, and the like), a feature descriptor algorithm (for example, such as Binary Robust Independent Elementary Features (BRIEF), Gradient Location and Orientation Histogram (GLOH), Histogram of Oriented Gradients (HOG), and the like), a feature detector algorithm (for example, such as the SIFT, the SURF, Oriented FAST and rotated BRIEF (ORB), and the like). Such data processing algorithms are well-known in the art.

It will be appreciated that the at least one server need not identify the objects or their parts in the first image and the second image, but only need to identify image segments of the first image and the second image that represent a same object, wherein the same object is in-focus in the first image, but is out-of-focus in the second image. It will also be appreciated that the at least one image segment of the first image and the corresponding image segment of the second image can also be identified, for example, by using contrast analysis, edge detection, Fourier analysis, or similar.

Alternatively, optionally, the step of identifying the at least one image segment of the first image and the corresponding image segment of the second image comprises:
identifying a plurality of image segments of the first image and a plurality of image segments of the second image that represent same objects that are present in the real-world environment;
computing weights for the plurality of image segments of the first image and the plurality of image segments of the second image, wherein a weight of a given image segment is calculated based on at least one of:
   a gradient of optical depth across the given image segment, when a given same object is out-of-focus in the given image segment,
   a difference in optical depth between the given same object and a neighbourhood of the given same object, when the given same object is out-of-focus in the given image segment,
   a contrast of features in the given image segment, when the given same object is in-focus in the given image segment; and
selecting the at least one image segment of the first image and the corresponding image segments of the second image, from amongst the plurality of image segments of the first image and the plurality of image segments of the second image, based on the weights computed for the plurality of image segments of the first image and the plurality of image segments of the second image.

The correlation between the pixels of the at least one image segment of the first image and the respective pixels of the corresponding image segment of the second image refers to a mathematical relation between the pixel values of the pixels of the at least one image segment of the first image and the pixel values of the respective pixels. The aforesaid correlation can be determined in a manner as mentioned earlier. Furthermore, since the plurality of depth maps are obtained by the at least one server, the respective optical depths in the at least one segment of the first depth map are readily available to the at least one server. Therefore, the PSF for the at least one camera can be determined as a function of optical depth, using the aforesaid correlation, and the respective optical depths in the at least one segment of the first depth map. It will be appreciated that such a manner of determining the PSF is highly accurate and reliable.

In an embodiment, the computer-implemented method further comprises:
obtaining information indicative of a gaze direction of a user;
determining a gaze region in the third image, based on the gaze direction of the user; and
applying the extended depth-of-field correction to the at least one image segment of the third image that is out of focus, only when the at least one image segment of the third image overlaps with the gaze region.

In this regard, the information indicative of gaze directions of the user's eyes are received from the devices of the N users. These devices comprise respective gaze-tracking means. The term “gaze-tracking means” refers to a specialized equipment for detecting and/or following gaze of the user. The term “gaze direction” refers to a direction in which the user is gazing. The gaze direction may be indicated by a gaze vector. The gaze-tracking means could be implemented as contact lenses with sensors, cameras monitoring a position, a size and/or a shape of a pupil of the user's eyes, and the like. Such gaze-tracking means are well-known in the art. It will be appreciated that the information indicative of the gaze direction of the user is received repeatedly, as user's gaze keeps changing.

The term “gaze region” refers to a gaze-contingent area in the real-world environment whereat the gaze direction of the user is directed (namely, focused). The gaze region may depend on accuracy of the gaze-tracking means as well as a size of a natural human gaze region for an optical depth at which the user is gazing. It will be appreciated that when the user's gaze is directed (namely, focused) towards a point or a region within the real-world environment, a gaze direction of a first eye and a gaze direction of a second eye of the user are different from each other, and both the gaze directions will converge at said point or said region. Since the gaze direction of the user in the real-world environment is known, the gaze region could be easily and accurately determined in the real-world environment. When the at least one image segment of the third image overlaps with the gaze region, it is beneficial to deblur the at least one image segment of the third image as compared to other (remaining) image segments of the third image. Thus, the at least one server applies the EDOF correction selectively to the at least one image segment of the third image, so that the at least one image segment (representing gaze-contingent objects) of the third image could be perceived by the user with a high visual acuity. Beneficially, the user experiences high gaze-contingency and considerable realism upon viewing the third image upon the EDOF correction. In this manner, processing resources and processing time of the at least one server could be minimized as the EDOF correction is applied only when the at least one image segment of the third image overlaps with the gaze region. Thus, when the at least one image segment of the third image does not overlap with (i.e., lies outside) the gaze region, the EDOF correction need not be applied. It will be appreciated that steps of the aforesaid embodiment could be implemented by the at least one server or by the device.

Optionally, in the computer-implemented method, the at least one sequence of images comprises two sequences of images, one of the two sequences comprising left images for a left eye of a user, another of the two sequences comprising right images for a right eye of the user, the at least one camera comprising a left camera and a right camera, and wherein the step of applying the extended depth-of-field correction comprises applying the extended depth-of-field correction to the left images and the right images in an alternating manner.

In this regard, the EDOF correction is applied to:
an M^{th} left image (but not to an M^{th} right image),
an (M+1)^{th} right image (but not to an (M+1)^{th} left image),
an (M+2)^{th} left image (but not to (M+2)^{th} right image), and so on.

The technical benefit of applying the EDOF correction in the aforesaid manner is that it facilitates in saving processing resources and processing time of the at least one server, as the EDOF correction would not be applied to both the left image and the right of the given stereo-image pair. It will be appreciated that even when the EDOF correction is applied selectively in the aforesaid manner, a high visual quality is achieved in a combined view of a given stereo-image pair. Notably, human binocular vision fuses the left image and the right image of the given stereo-image pair into one, such that human brain picks up a better contrasted image from amongst the left image and the right image. In this way, the user would still experience acceptably high realism and immersiveness upon viewing the combined view of the given stereo-image pair, because of the human binocular vision. This also allows the at least one server to serve multiple users simultaneously.

The present disclosure also relates to the system and to the computer program product as described above. Various embodiments and variants disclosed above, with respect to the aforementioned first aspect, apply mutatis mutandis to the system and to the computer program product.

Optionally, the at least one server is configured to assume that an entirety of the first image is in focus, whilst an entirety of the second image is out of focus, and wherein the point spread function is determined based on a correlation between pixels of the first image and respective pixels of the second image, and the first focusing distance range.

Alternatively, optionally, in the system, the at least one server is configured to:
obtain a plurality of depth maps captured corresponding to the images in said sequence; and
identify at least one image segment of the first image and a corresponding image segment of the second image in which the at least one image segment of the first image is in focus whilst the corresponding image segment of the second image is out of focus,
   wherein the point spread function is determined, based on a correlation between pixels of the at least one image segment of the first image and respective pixels of the corresponding image segment of the second image, and respective optical depths in at least one segment of a first depth map corresponding to the at least one image segment of the first image.

Optionally, in the system, the at least one server is configured to:
obtain information indicative of a gaze direction of a user;
determine a gaze region in the third image, based on the gaze direction of the user; and
apply the extended depth-of-field correction to the at least one image segment of the third image that is out of focus, only when the at least one image segment of the third image overlaps with the gaze region.

Optionally, the at least one sequence of images comprises two sequences of images, one of the two sequences comprising left images for a left eye of a user, another of the two sequences comprising right images for a right eye of the user, the at least one camera comprising a left camera and a right camera, and

wherein the at least one server is configured to apply the extended depth-of-field correction to the left images and the right images in an alternating manner.

### DETAILED DESCRIPTION OF THE DRAWINGS

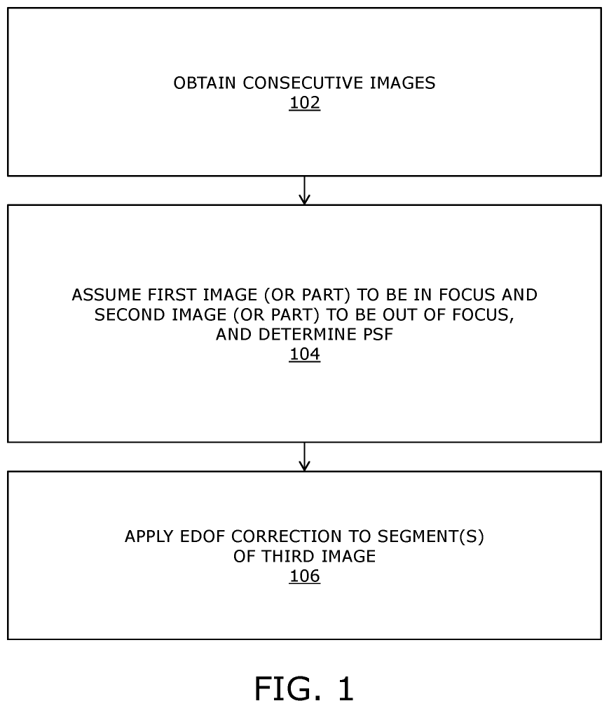

Referring to FIG. 1, illustrated are steps of a computer-implemented method for determining point spread function from consecutive images, in accordance with an embodiment of the present disclosure. At step 102, at least one sequence of images of a real-world environment captured consecutively using at least one camera is obtained, wherein an optical focus of the at least one camera is switched between different focusing distances whilst capturing consecutive images of said sequence. For a given pair of a first image and a second image that are captured consecutively in said sequence by adjusting the optical focus of the at least one camera at a first focusing distance and a second focusing distance, respectively, at step 104, it is assumed that at least a part of the first image is in focus, whilst a corresponding part of the second image is out of focus; and a point spread function is determined for the at least one camera, based on a correlation between pixels of at least the part of the first image and respective pixels of the corresponding part of the second image, and a first focusing distance range covered by a depth of field of the at least one camera around the first focusing distance. For a third image of the real-world environment captured by adjusting the optical focus of the at least one camera at a third focusing distance, at step 106, an extended depth-of-field correction is applied to at least one segment of the third image that is out of focus, by using the point spread function determined for the at least one camera.

The aforementioned steps are only illustrative and other alternatives can also be provided where one or more steps are added, one or more steps are removed, or one or more steps are provided in a different sequence without departing from the scope of the claims herein.

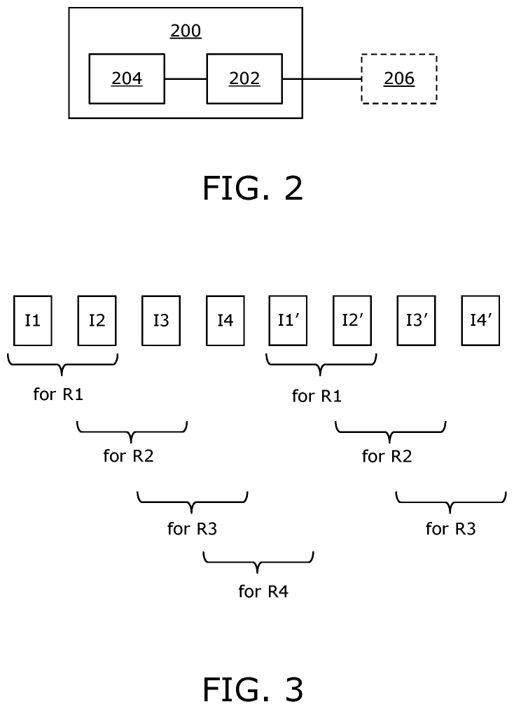

Referring to FIG. 2, illustrated is a block diagram of a system 200 for determining point spread function from consecutive images, in accordance with an embodiment of the present disclosure. The system 200 comprises at least one server (depicted as a server 202) and, optionally, a data repository 204 communicably coupled to the server 202. Optionally, the server 202 is communicably coupled to at least one camera (depicted as a camera 206) or to a device comprising the at least one camera.

It may be understood by a person skilled in the art that FIG. 2 includes a simplified architecture of the system 200, for sake of clarity, which should not unduly limit the scope of the claims herein. It is to be understood that the specific implementation of the system 200 is provided as an example and is not to be construed as limiting it to specific numbers or types of servers, data repositories, and cameras. The person skilled in the art will recognize many variations, alternatives, and modifications of embodiments of the present disclosure.

Referring to FIG. 3, illustrated is how a point spread function is determined using exemplary cycles of consecutive images, in accordance with an embodiment of the present disclosure. Herein, a first cycle comprises four consecutive images I1, I2, I3, and I4, which are captured by adjusting an optical focus of a camera (not shown) according to four fixed focusing distances D1, D2, D3, and D4, which correspond to four focusing distance ranges R1, R2, R3, and R4 of the camera, respectively. A second cycle comprises four consecutive images I1′, I2′, I3′, and I4′, which are captured by adjusting the optical focus of the camera according to the four fixed focusing distances D1, D2, D3, and D4 corresponding to the four focusing distance ranges R1, R2, R3, and R4 of the camera, respectively.

By correlating pixels of the image I1 and respective pixels of the image I2, and assuming the image I1 to be in focus and the image I2 to be out-of-focus, a PSF for the focusing distance range R1 (including the focusing distance D1) can be determined. By correlating pixels of the image I2 and respective pixels of the image I3, and assuming the image I2 to be in focus and the image I3 to be out-of-focus, a PSF for the focusing distance range R2 (including the focusing distance D2) can be determined. Likewise, by correlating pixels of the image I3 and respective pixels of the image I4, and assuming the image I3 to be in focus and the image I4 to be out-of-focus, a PSF for the focusing distance range R3 (including the focusing distance D3) can be determined. By correlating pixels of the image I4 and respective pixels of the image I1′, and assuming the image I4 to be in focus and the image I1′ to be out-of-focus, a PSF for the focusing distance range R4 (including the focusing distance D4) can be determined. This process can be repeated in a similar manner for other consecutive images.

Consider an example of the image I3, where objects present within the focusing distance range R3 (namely, at the optical depth D3 and its associated depth of field) would be captured sharply (namely, well-focused). However, some objects which are present within focusing distance range(s) other than the focusing distance range R3 would be out of focus (namely, blurred). Thus, EDOF correction(s) can be applied to at least one image segment of the image I3, using at least one of: the PSF determined for the focusing distance range R1, the PSF determined for the focusing distance range R2, the PSF determined for the focusing distance range R4.

FIG. 3 is merely an example, which should not unduly limit the scope of the claims herein. The person skilled in the art will recognize many variations, alternatives, and modifications of embodiments of the present disclosure.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A computer-implemented method comprising:
obtaining at least one sequence of images of a real-world environment captured consecutively using at least one camera, wherein an optical focus of the at least one camera is switched between different focusing distances whilst capturing consecutive images of said sequence;
for a given pair of a first image and a second image that are captured consecutively in said sequence by adjusting the optical focus of the at least one camera at a first focusing distance and a second focusing distance, respectively,
assuming that at least a part of the first image is in focus, whilst a corresponding part of the second image is out of focus; and
determining a point spread function for the at least one camera, based on a correlation between pixels of at least the part of the first image and respective pixels of the corresponding part of the second image, and a first focusing distance range covered by a depth of field of the at least one camera around the first focusing distance; and
for a third image of the real-world environment captured by adjusting the optical focus of the at least one camera at a third focusing distance, applying an extended depth-of-field correction to at least one segment of the third image that is out of focus, by using the point spread function determined for the at least one camera.

2. The computer-implemented method of claim 1, wherein the step of assuming comprises assuming that an entirety of the first image is in focus, whilst an entirety of the second image is out of focus, and wherein the point spread function is determined based on a correlation between pixels of the first image and respective pixels of the second image, and the first focusing distance range.

3. The computer-implemented method of claim 1, further comprising:
obtaining a plurality of depth maps captured corresponding to the images in said sequence; and
identifying at least one image segment of the first image and a corresponding image segment of the second image in which the at least one image segment of the first image is in focus whilst the corresponding image segment of the second image is out of focus,
wherein the step of determining the point spread function is performed, based on a correlation between pixels of the at least one image segment of the first image and respective pixels of the corresponding image segment of the second image, and respective optical depths in at least one segment of a first depth map corresponding to the at least one image segment of the first image, wherein said part of the first image comprises the at least one image segment of the first image.

4. The computer-implemented method of claim 1, further comprising:
obtaining information indicative of a gaze direction of a user;
determining a gaze region in the third image, based on the gaze direction of the user; and
applying the extended depth-of-field correction to the at least one image segment of the third image that is out of focus, only when the at least one image segment of the third image overlaps with the gaze region.

5. The computer-implemented method of claim 1, wherein the at least one sequence of images comprises two sequences of images, one of the two sequences comprising left images for a left eye of a user, another of the two sequences comprising right images for a right eye of the user, the at least one camera comprising a left camera and a right camera, and
wherein the step of applying the extended depth-of-field correction comprises applying the extended depth-of-field correction to the left images and the right images in an alternating manner.

6. The computer-implemented method of claim 1, wherein the optical focus of the at least one camera is switched between N different focusing distances whilst capturing consecutive images of said sequence, the N different focusing distances comprising fixed focusing distances.

7. The computer-implemented method of claim 1, wherein the optical focus of the at least one camera-P-010 is switched between N different focusing distances whilst capturing consecutive images of said sequence, wherein the N different focusing distances correspond to optical depths at which N users are gazing.

8. The computer-implemented method of claim 1, wherein the third image is any one of: a previous image in said sequence, a subsequent image in said sequence, the second image.

9. A system comprising:
at least one server configured to:
obtain at least one sequence of images of a real-world environment captured consecutively using at least one camera, wherein an optical focus of the at least one camera is switched between different focusing distances whilst capturing consecutive images of said sequence;
for a given pair of a first image and a second image that are captured consecutively in said sequence by adjusting the optical focus of the at least one camera at a first focusing distance and a second focusing distance, respectively,
assume that at least a part of the first image is in focus, whilst a corresponding part of the second image is out of focus; and
determine a point spread function for the at least one camera, based on a correlation between pixels of at least the part of the first image and respective pixels of the corresponding part of the second image, and a first focusing distance range covered by a depth of field of the at least one camera around the first focusing distance; and
for a third image of the real-world environment captured by adjusting the optical focus of the at least one camera at a third focusing distance, apply an extended depth-of-field correction to at least one segment of the third image that is out of focus, by using the point spread function determined for the at least one camera.

10. The system of claim 9, wherein the at least one server is configured to assume that an entirety of the first image is in focus, whilst an entirety of the second image is out of focus, and wherein the point spread function is determined based on a correlation between pixels of the first image and respective pixels of the second image, and the first focusing distance range.

11. The system of claim 9, wherein the at least one server is configured to:
obtain a plurality of depth maps captured corresponding to the images in said sequence; and
identify at least one image segment of the first image and a corresponding image segment of the second image in which the at least one image segment of the first image is in focus whilst the corresponding image segment of the second image is out of focus,
wherein the point spread function is determined, based on a correlation between pixels of the at least one image segment of the first image and respective pixels of the corresponding image segment of the second image, and respective optical depths in at least one segment of a first depth map corresponding to the at least one image segment of the first image, wherein said part of the first image comprises the at least one image segment of the first image.

12. The system of claim 9, wherein the at least one server is configured to:
obtain information indicative of a gaze direction of a user;
determine a gaze region in the third image, based on the gaze direction of the user; and
apply the extended depth-of-field correction to the at least one image segment of the third image that is out of focus, only when the at least one image segment of the third image overlaps with the gaze region.

13. The system of claim 9, wherein the at least one sequence of images comprises two sequences of images, one of the two sequences comprising left images for a left eye of a user, another of the two sequences comprising right images for a right eye of the user, the at least one camera comprising a left camera and a right camera, and
wherein the at least one server is configured to apply the extended depth-of-field correction to the left images and the right images in an alternating manner.

14. The system of claim 9, wherein the optical focus of the at least one camera is switched between N different focusing distances whilst capturing consecutive images of said sequence, the N different focusing distances comprising fixed focusing distances.

15. The system of claim 9, wherein the optical focus of the at least one camera is switched between N different focusing distances whilst capturing consecutive images of said sequence, wherein the N different focusing distances correspond to optical depths at which N users are gazing.

16. The system of claim 9, wherein the third image is any one of: a previous image in said sequence, a subsequent image in said sequence, the second image.

17. A computer program product comprising a non-transitory machine-readable data storage medium having stored thereon program instructions that, when executed by a processor, cause the processor to execute steps of a computer-implemented method of claim 1.
